(19) United States
(12) Patent Application Publication
(10) Pub. No.: US 2008/0232633 A1
(43) Pub. Date: Sep. 25, 2008

(54) Shallow Loudspeaker

(75) Inventor: David Magda Eddy Corynen, Dendermonde (BE)

Correspondence Address: SHEEHAN PHINNEY BASS & GREEN, PA;c/o PETER NIEVES, 1000 ELM STREET, MANCHESTER, NH, 03105-3701, US

(73) Assignee: PSS Belgium N.V.

(21) Appl. No.: 10/567,215

(22) PCT Filed: Jul. 30, 2004
(86) PCT No.: PCT/IB04/51336

§ 371 Date: Feb. 3, 2006

(30) Foreign Application Priority Data
Aug. 8, 2003 (EP) 03102482.1

(51) Int. Cl. H04R 9/06; H04R 7/14

(52) U.S. Cl. 381/396

(57) ABSTRACT

Loudspeaker provided with a frame (101), a membrane (103) and a drive unit (105. The membrane has a flat outer circumferential edge (104a) suspended from the frame, and a flat inner circumferential edge (104b). The drive unit has a stationary part (106a) secured to the frame and a translatable part (106b) provided with a coil support (108b) secured to the inner circumferential edge of the membrane. The membrane includes a concave membrane body (104), which, viewed in a circumferential direction, has a pattern of folds radially extending between the flat inner circumferential edge and the flat outer circumferential edge of the membrane, which pattern of folds improves the stiffness of the membrane.

The invention relates to a loudspeaker which is provided with a frame, a membrane and a drive unit.

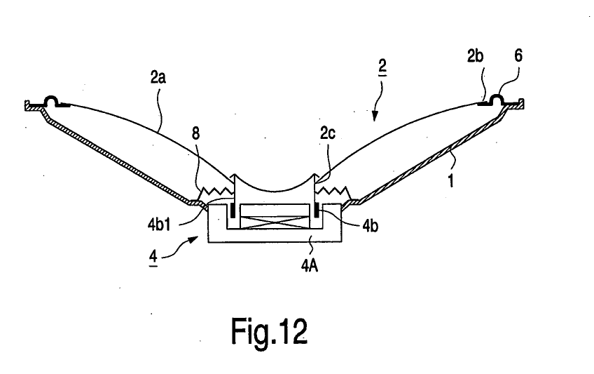

Such speakers are generally known. FIG. 12 of the accompanying drawing shows a known loudspeaker. This speaker has a frame (1), a membrane (2) and an electromagnetic drive unit (B. The membrane is formed by a conical body (2a) and has a flat outer circumferential edge (2b) and a flat inner circumferential edge (2c). The drive unit is provided with a stationary part (4a) and a movable part (4b). The stationary part, which includes a permanent magnet and a magnetic yoke, is secured to the frame. The movable part includes a voice coil and a cylindrical coil support (4b1). At its outer circumferential edge, the membrane is connected to the frame by means of a flexible suspension (6) and at its inner circumferential edge, it is adhered to the coil support, which in its turn is connected to the frame by means of a spider (8).

The conventional conical body of the membrane of the depicted known loudspeaker has a certain height in order to obtain sufficient stiffness. The membrane should have a certain minimal stiffness in order to be able to move like a piston for low-frequency reproduction and to have a controlled behavior at and above the first break-up of the membrane for mid and high-frequency reproduction. For this reason, there arise problems relating to the speaker's performance if a shallow speaker, i.e. a speaker having a small height, is required in certain applications.

JP-A 54-6523 discloses a shallow speaker, which is provided with a faintly conical diaphragm having a corrugation structure for improving the behavior of the diaphragm. The diaphragm has an outer circumferential part glued to an elastic suspension ring and an inner circumferential part glued to a voice-coil bobbin. The corrugation structure is formed by radial corrugations which decrease towards the outer circumferential part and increase towards the inner circumferential part. Due to this structure, the outer circumferential part includes a flat ring-shaped outer edge glued to the suspension ring, and the inner circumferential part includes an undulating inner edge glued to the bobbin.

Although the speaker known from JP-A 54-6523 comprises means for solving the above-mentioned problems relating to the performance, it causes a manufacturing problem, particularly as to the fixation of the corrugated diaphragm to the voice-coil bobbin.

It is an object of the invention to provide a loudspeaker which can be given a small height without deteriorating its sound performance and without hampering its manufacture.

This object is achieved with the loudspeaker according to the invention, which is provided with a frame, a membrane and a drive unit, the membrane having a substantially flat outer circumferential edge suspended from the frame, and a substantially flat inner circumferential edge, the drive unit having a stationary part secured to the frame and provided with a magnet system, and a translatable part provided with a coil support secured to the substantially flat inner circumferential edge of the membrane and comprising an electric coil, wherein the membrane includes a concave membrane body which, viewed in a circumferential direction, has a pattern of folds radially extending between the substantially flat inner circumferential edge and the substantially flat outer circumferential edge of the membrane. It is to be noted that the expression “substantially flat” has the meaning of flat or practically flat in this document. A deviation, if any, of flatness of the edges must be small as compared with the maximal height and/or depth of the folds.

The loudspeaker according to the invention is provided with a membrane which is only undulated in an area extending between its substantially flat circumferential edges. Because of this measure, the loudspeaker according to the invention is production-friendly because the circumferential edges are or are at least practically flat, whereby the connection of the membrane with the frame and the fixation of the membrane to the coil support can take place in conventional ways generally known for mounting membranes having flat circumferential edges. It is common practice e.g. to glue a flat inner circumferential edge of a membrane to the coil support. In this context, it is to be noted that the radial folds of the diaphragm applied in the speaker disclosed in JP-A 54-6523 are cut off, as it were, in the inner circumferential edge of the diaphragm, whereby this edge itself is undulating. It has appeared that it is difficult to glue such an undulating edge to a voice-coil bobbin. The way in which this has to be done is quite different from what present automated speaker-lines can handle. This means that the mounting of known undulating diaphragms requires extra investments in new glue-robots. A problem arising during positioning of the diaphragm with regard to the voice-coil bobbin is e.g. that already a small inclination of the membrane causes such an offset between the tops and troughs of the undulated inner edge of the diaphragm that gliding of the diaphragm over the bobbin is hindered.

Because of the specific corrugated structure applied in the membrane body of the loudspeaker according to the invention, the membrane is reinforced over its surface and has sufficient stiffness to be suitable as a shallow or flat membrane. The degree of undulations depends on the shape of the folds. In principle, the folds may have any shape, such as round or sharp, wherein the pattern may have tops and troughs. The pattern of folds may be uniform or non-uniform, viewed in a circumferential direction.

A shallow loudspeaker provided with a membrane as described above has an excellent sound performance, due to its good behavior at and above the first break-up. In other words, also at and above the break-up there is little distortion of the reproduced sound.

The folds preferably have a depth and/or height, measured from the membrane body, which smoothly decreases to the substantially flat outer circumferential edge and/or the substantially flat inner circumferential edge of the membrane.

In a practical embodiment, the membrane body is a concave body, particularly a slightly concave body, the substantially flat inner circumferential edge and the substantially flat outer circumferential edge being in parallel planes. The membrane body is preferably cone-shaped. In general, the inner circumferential edge is circular; the outer circumferential edge may have a different shape, such as more or less elliptical.

Another practical embodiment has the feature that the membrane body is, in principle, a flat body, the substantially flat inner circumferential edge and the substantially flat outer circumferential edge being in substantially coinciding planes.

It is practical to adhere the membrane to the movable part of the drive unit, particularly to the coil support thereof. An existing glue may be used for this purpose.

In certain applications, it may be preferred to apply a non-uniform pattern of folds. Acoustical properties of the loudspeaker and/or mechanical properties of the membrane can be adjusted by varying the degree of non-uniformity. Moreover, several shapes of folds are applicable.

It is to be noted that the loudspeaker according to the invention is suitable for sound reproduction in hifi, home, automotive, TV and multimedia systems and, as already stated, it is particularly suitable for applications having very small build-in depths.

The invention also relates to a membrane as defined in claim 9.

With regard to the claims, it is noted that various combinations of embodiments and features as described in the claims are possible within the scope of the invention.

The invention will now be described in more detail, by way of example, with reference to the drawings, in which

FIG. 1 shows diagrammatically in a cross-section an embodiment of the loudspeaker according to the invention,

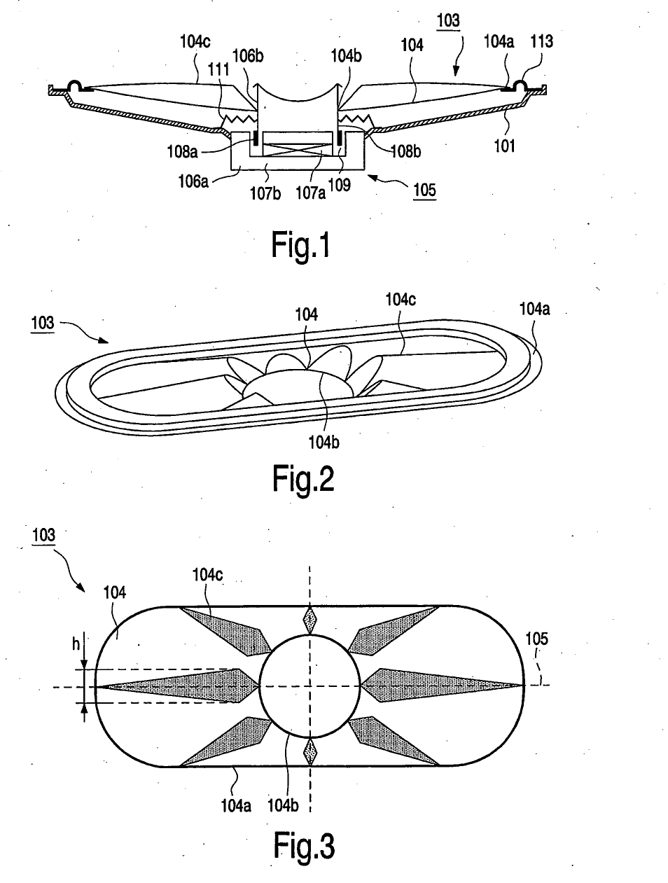

FIG. 2 is a diagrammatical perspective view of the membrane of the embodiment shown in FIG. 1,

FIG. 3 is a shape-fold distribution diagram of the membrane of the embodiment shown in FIG. 1,

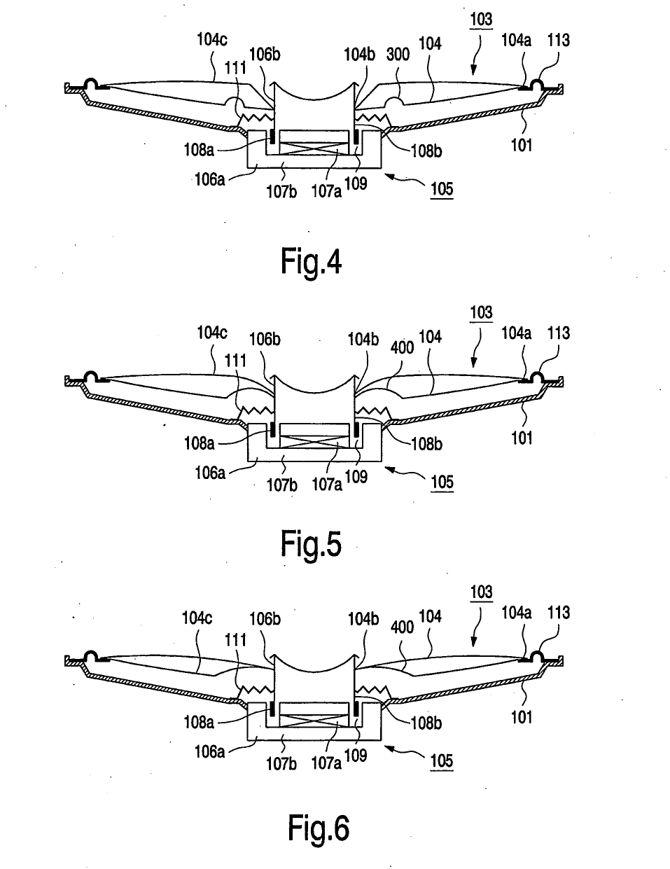

FIGS. 4 to 10 show diagrammatically in cross-sections variants of the embodiment 1 shown in FIG. 1,

FIG. 11 is a diagram displaying several suitable shapes of folds, and

FIG. 12 shows diagrammatically a conventional loudspeaker.

The loudspeaker depicted in FIGS. 1 to 3 is provided with a frame 101, a membrane 103 and an electromagnetic drive unit 105. The membrane 103 has a shallow concave membrane body 104 provided with a flat outer circumferential edge 104a and a flat inner circumferential edge 104b and is provided with a pattern of radial folds 104c, which pattern extends over the surface of the membrane 104, viewed in circumferential direction. The folds 104c, which are formed by tops, have a height (h) which increases from the outer edge 104a towards the inner edge 104b, the maximum height being located at some distance from the inner edge. The membrane body 104 may be made of e.g. paper, particularly reinforced paper. The drive unit 105 comprises a stationary part 106a and a movable, i.e. translatable, part 106b. The stationary part 106a is secured to the frame 101 and has a magnet system including a permanent magnet 107 and a magnetic yoke 107b, and the translatable part 106b has a coil system including a voice coil 108a and a coil former or support 108b on which the coil 108a is attached. The magnet system and the coil system can magnetically cooperate with each other through an air gap 109. The coil support 108b is adhered to the flat inner circumferential edge 104b by means of a suitable glue which may be a known glue.

The coil support 108b is connected to the frame 101 by means of a spider 122, in a way known per se.

The outer circumferential edge 104a is connected to the frame 101 by a resilient means 113, such as a roll-collar known per se and made of e.g. rubber or foam.

In this embodiment, the folds 104c, which have a radial axis 105, smoothly attenuate on nearing the outer circumferential edge 104c. The folds 104c terminate in the vicinity of the inner edge 104b in such a way that the membrane body 104 can provide the desired flat inner edge.

FIGS. 4 to 10 show several further embodiments. As far as possible, the same reference signs are used for corresponding parts.

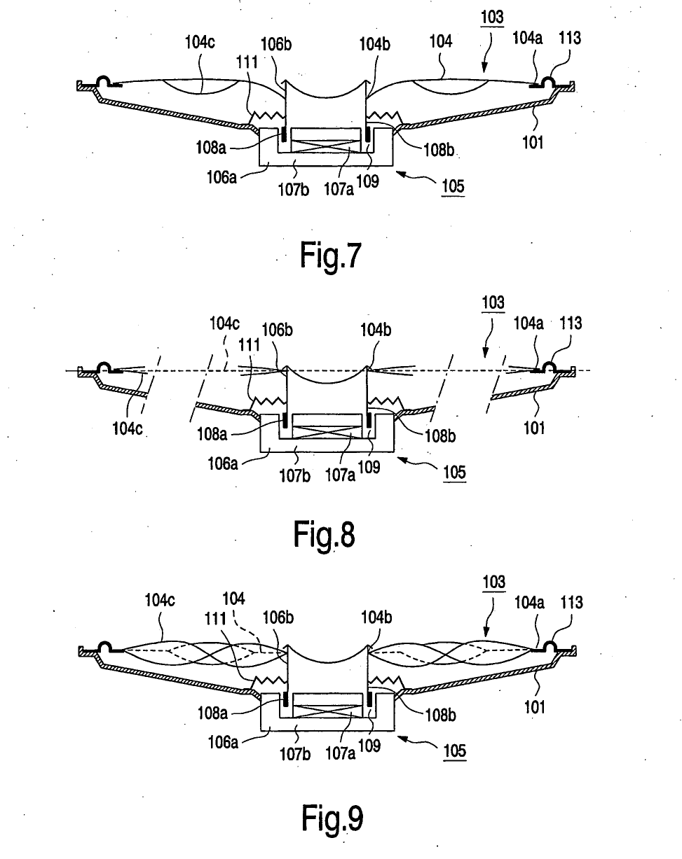

In the loudspeakers depicted in FIG. 4, the membrane body 104 is provided with a ring-shaped recess 300, viewed from the drive unit 105, in order to enlarge the stroke of the translatable part 106b of the drive unit 105. The recess 300 is located at some distance from the flat inner circumferential edge 104b. A variant of the recess 300 is applied in the membrane body 104 of the loudspeaker depicted in FIG. 5. This recess, indicated by 400, borders on the inner edge 104b. In this example, the folds 104c smoothly attenuate towards the inner edge 104b. The membrane body 104 of the loudspeaker depicted in FIG. 6 is provided with folds 104c shaped by troughs. A variant of this membrane body 104 is applied in the loudspeaker depicted in FIG. 7. In this variant, the structure of folds 104c is only provided in a restricted area between the edges 104 and 104b.

In contrast to the embodiments disclosed in FIGS. 1 to 7, wherein the edges 104a and 204b are positioned in parallel planes which extend at a small distance from each other, the embodiment depicted in FIG. 8 has a flat outer edge 104a and a flat inner edge 104b which are positioned in the same plane. The membrane body 104 is provided with a sinuating pattern of folds 104c, viewed in a circumferential direction.

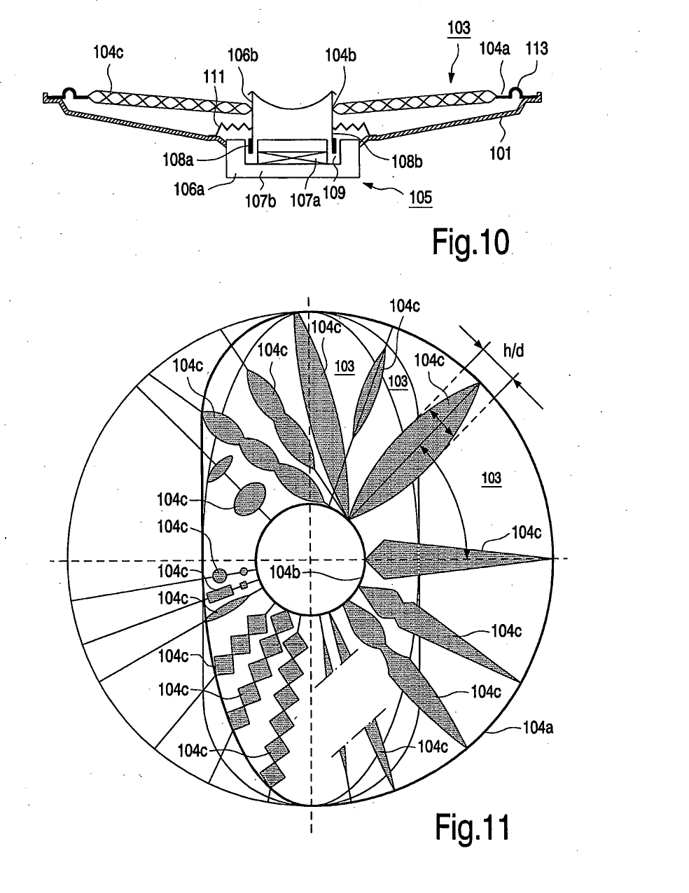

In the variants shown in FIGS. 9 and 10, the folds of the structure of folds have an undulating pattern in a radial direction.

The diagrammatical presentation in FIG. 11 displays several possible shapes of folds and shapes of membranes. The membranes, which are indicated by 103, have a substantially flat outer edge 104a and a substantially flat inner edge 104b. The folds, which are denoted by the reference numeral 104c, may be regularly or irregularly distributed across the membrane face, dependent on the required properties of the membrane. The folds may have tops and/or troughs and thus have a height (h) and/or a depth (d) with regard to the membrane face. Several kinds of folds can be applied in combination, if desired.

It is to be noted that the disclosed embodiments are only given by way of example. Within the scope of the invention, it is possible to combine different features of several embodiments to build a loudspeaker according to the invention.

1. A loudspeaker provided with a frame (1), a membrane (3) and a drive unit (5), the membrane having a substantially flat outer circumferential edge suspended from the frame, and a substantially flat inner circumferential edge, the drive unit having a stationary part secured to the frame and provided with a magnet system, and a translatable part provided with a coil support secured to the substantially flat inner circumferential edge of the membrane and comprising an electric coil, wherein the membrane includes a membrane body (4), which, viewed in a circumferential direction, has a pattern of folds (4c) radially extending between the substantially flat inner circumferential edge and the substantially flat outer circumferential edge of the membrane, which folds have a depth, measured from the membrane body, which smoothly decreases towards the substantially flat outer circumferential edge of the membrane.

2. A loudspeaker as claimed in claim 1, wherein the membrane body is a concave body, the substantially flat inner circumferential edge and the substantially flat outer circumferential edge being in parallel planes.

3. A loudspeaker as claimed in claim 1, wherein the membrane body is, in principle, a flat body, the substantially flat inner circumferential edge and the substantially flat outer circumferential edge being in substantially coinciding planes.

4. A loudspeaker as claimed in claim 1, wherein the substantially flat inner circumferential edge of the membrane is adhered to the coil support of the translatable part of the drive unit.

5. A loudspeaker as claimed in claim 1, wherein the depth of the folds smoothly decreases towards the substantially flat inner circumferential edge of the membrane.

6. A loudspeaker as claimed in claim 1, wherein the membrane edge has an inner portion adjoining the substantially flat inner circumferential edge of the membrane, which portion recedes, viewed from the magnet system.

7. A loudspeaker as claimed in claim 1, wherein the pattern of folds is a non-uniform pattern, viewed in a circumferential and/or radial direction.

8. A membrane intended for use in a loudspeaker, including a membrane body, which, viewed in a circumferential direction, has a pattern of folds radially extending between a flat inner circumferential edge and a flat outer circumferential edge, wherein the folds have a depth, measured from the membrane body, which smoothly decreases towards the flat outer circumferential edge.

9. A membrane as claimed in claim 8, wherein the depth of the folds smoothly decreases towards the flat inner circumferential edge.

10. Use of the membrane as claimed in claim 8 or 9 in a loudspeaker.
